(19) United States
(12) Patent Application Publication
(10) Pub. No.: US 2023/0279190 A1
(43) Pub. Date: Sep. 7, 2023

(54) RESIN SHEET, CONTAINER, CARRIER TAPE, AND ELECTRONIC COMPONENT PACKAGING BODY

(71) Applicant: Denka Company Limited, Chuo-ku, Tokyo (JP)

(72) Inventors: Ryosuke YANAKA, Chuo-ku, Tokyo (JP); Takeshi SAITO, Chuo-ku, Tokyo (JP); Kota SAWAGUCHI, Chuo-ku, Tokyo (JP)

(73) Assignee: Denka Company Limited, Chuo-ku, Tokyo (JP)

(21) Appl. No.: 18/005,784

(22) PCT Filed: Jun. 7, 2021
(86) PCT No.: PCT/JP2021/021607

§ 371 Date: Jan. 17, 2023

(30) Foreign Application Priority Data
Aug. 5, 2020 (JP) 2020-133014

(51) Int. Cl. C08J 5/18; C08K 3/04; C08L 9/06; C08L 69/00; B65D 75/28; B32B 27/36; B32B 27/30; B32B 27/08; B32B 27/20; B32B 7/02

(52) U.S. Cl. CPC C08J 5/18; C08K 3/04; C08L 9/06; C08L 69/00; B65D 75/28; B32B 27/365; B32B 27/302; B32B 27/08; B32B 27/20; B32B 7/02; C08J 2309/06; C08J 2369/00; C08J 2409/06; C08J 2469/00; C08K 2201/005; C08K 2201/001; B32B 2270/00; B32B 2307/558; B32B 2264/108; B32B 2264/303; B32B 2307/546; B32B 2439/40; B32B 2250/24

(57) ABSTRACT

A resin sheet is for molding, has an impact strength of 1.0 J or greater in a DuPont impact test, and has a value of 80 N/m² or smaller obtained through integration from an origin point to a strain when fracture has occurred in a stress strain curve obtained in a tensile test. A carrier tape 100 is a molded body 16 of the resin sheet, wherein an accommodation portions 20 capable of accommodating an article is provided.

### TECHNICAL FIELD

The present invention relates to a resin sheet, a container, a carrier tape, and an electronic component packaging body.

### BACKGROUND ART

Vacuum-molded trays, embossed carrier tapes, and the like obtained by heat-molding a resin sheet are used as packaging containers for intermediate products of industrial products such as electronic instruments and automobiles. Further, a laminated sheet in which a surface layer containing a thermoplastic resin and a conductive material such as carbon black is laminated on a base material layer made of a thermoplastic resin is used as a sheet for a packaging container for ICs which dislike static electricity and various kinds of components having an IC (for example, refer to the following Patent Literature 1 to Patent Literature 3). When a carrier tape is produced, a slit product or the like obtained by slit processing of a raw material sheet is used as necessary. In an embossed carrier tape, sprocket holes or the like used for conveyance in a step of enclosing various kinds of electronic components such as ICs, or the like are provided (for example, refer to Patent Literature 4).

### CITATION LIST

### Patent Literature

[Patent Literature 1] Japanese Unexamined Patent Publication No. H9-76422

[Patent Literature 2] Japanese Unexamined Patent Publication No. H9-76425

[Patent Literature 3] Japanese Unexamined Patent Publication No. H9-174769

[Patent Literature 4] Japanese Unexamined Patent Publication No. H5-201467

### SUMMARY OF INVENTION

### Technical Problem

Recently, with the miniaturization of electronic components such as ICs, there has been a demand for carrier tapes and the like, with regard to the performance thereof, to have small burrs generated in a cross section thereof during slit processing of a raw material sheet or during punching of sprocket holes or the like.

On the other hand, there is also a need for resin sheets for forming embossed carrier tape to have a sufficient folding resistance strength such that not only burrs due to punching or slit processing are unlikely to be generated but also cracking is unlikely to occur in known sheet molding methods such as vacuum molding, pressure molding, and press molding. In addition, in embossed carrier tapes or the like, accommodation portions for accommodating components are provided by embossing processing or the like, but if unevenness in thickness of side surfaces or bottom surfaces of the accommodation portions is significant, cracking or the like is likely to occur. Therefore, resin sheets are required to have moldability capable of sufficiently curbing unevenness in thickness of a molded body.

An object of the present invention is to provide a resin sheet which has a sufficient folding resistance strength and moldability and in which burrs due to punching or slit processing are unlikely to be generated, and a container, a carrier tape, and an electronic component packaging body which are obtained using the resin sheet.

### Solution to Problem

In order to resolve the foregoing problems, according to an aspect of the present invention, there is provided a resin sheet for molding, wherein the impact strength in a DuPont impact test is 1.0 J or greater, and wherein in a stress strain curve obtained in a tensile test, a value obtained through integration from an origin point to a strain when fracture has occurred is 80 N/m² or smaller.

In the resin sheet, at least one kind of a polycarbonate resin and an ABS resin can be contained.

The resin sheet can include a base material layer, and a surface layer laminated on at least one surface of the base material layer. The base material layer can include at least one kind of a polycarbonate resin and an ABS resin, and an inorganic filler. The surface layer can include at least one kind of a polycarbonate resin and an ABS resin, and a conductive material.

In the foregoing resin sheet, it is preferable that a content of the inorganic filler in the base material layer be 0.3 to 28 mass % based on a total amount of the base material layer.

In addition, it is preferable that an average primary particle size of the inorganic filler be 10 nm to 5.0 μm.

In addition, the base material layer can include carbon black as the inorganic filler.

In addition, it is preferable that a content of the conductive material in the surface layer be 10 to 30 mass % based on a total amount of the surface layer.

In addition, it is preferable that a thickness of the base material layer be 70% to 97% with respect to a thickness of the entire resin sheet.

According to another aspect of the present invention, there is provided a container that is a molded body of the foregoing resin sheet.

According to another aspect of the present invention, there is provided a carrier tape that is a molded body of the foregoing resin sheet, wherein an accommodation portion capable of accommodating an article is provided.

According to another aspect of the present invention, there is provided an electronic component packaging body including the carrier tape, an electronic component accommodated in the accommodation portion of the carrier tape, and a cover film adhered to the carrier tape as a lid material.

### Advantageous Effects of Invention

According to the present invention, it is possible to provide a resin sheet which has a sufficient folding resistance strength and moldability and in which burrs due to punching or slit processing are unlikely to be generated, and a container, a carrier tape, and an electronic component packaging body which are obtained using the resin sheet.

### BRIEF DESCRIPTION OF DRAWINGS

FIG. 1 is a schematic cross-sectional view illustrating an embodiment of a resin sheet.

FIG. 2 is a schematic cross-sectional view illustrating an embodiment of the resin sheet.

FIG. 3 is an explanatory view for a stress integrated value in a stress strain curve.

FIG. 4 is a partially-cut perspective view illustrating an embodiment of a carrier tape.

FIG. 5 is a partially-cut perspective view illustrating an embodiment of an electronic component packaging body.

### DESCRIPTION OF EMBODIMENT

Hereinafter, a suitable embodiment of the present invention will be described in detail.

[Resin Sheet]

A resin sheet of the present embodiment is a resin sheet for molding, and it may be a single layer sheet constituted of one layer or may be a laminated sheet in which a plurality of layers are laminated.

Examples of a single layer sheet include sheets constituted of a base material layer including a thermoplastic resin. A base material layer can further include an inorganic filler.

The foregoing single layer sheet can be used for molding a carrier tape or an electronic component packaging container. In addition, a single layer sheet including a conductive material such as carbon black as an inorganic filler can be used for molding an electronic component packaging container and is particularly suitable for molding a packaging container for ICs which dislike static electricity and various kinds of components having an IC.

A laminated sheet can be provided with a base material layer, and a surface layer laminated on at least one surface of the base material layer. The base material layer can include a first thermoplastic resin and an inorganic filler, and the surface layer can include a second thermoplastic resin and a conductive material. The first thermoplastic resin and the second thermoplastic resin may be the same resins or may be resins different from each other.

The foregoing laminated sheet can be used for molding a carrier tape or an electronic component packaging container and is particularly suitable for molding a packaging container for ICs which dislike static electricity and various kinds of components having an IC.

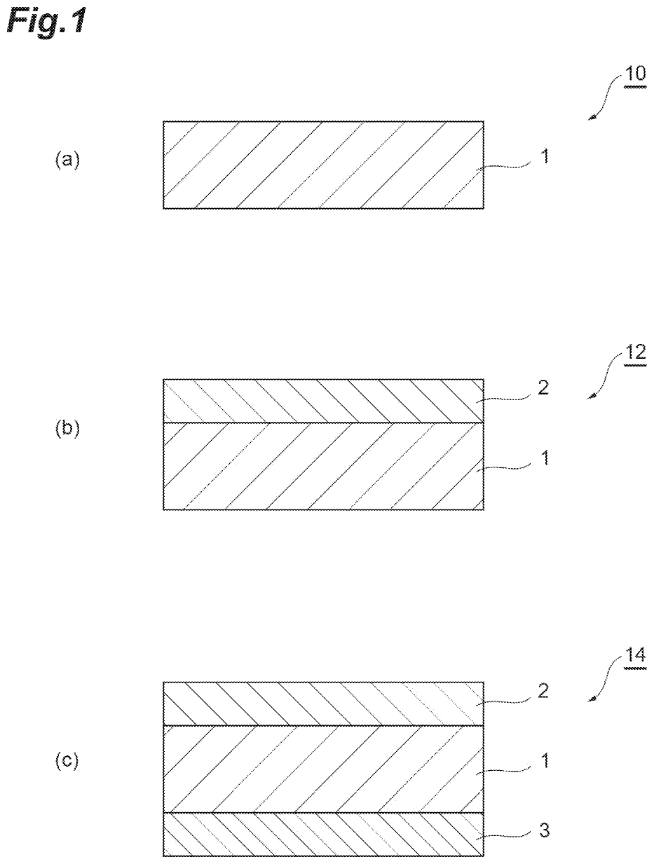

FIG. 1 is a schematic cross-sectional view illustrating an embodiment of a resin sheet of the present embodiment. A resin sheet illustrated in FIG. 1(a) is a single layer sheet constituted of a base material layer 1. A resin sheet 12 illustrated in FIG. 1(b) is a laminated sheet including the base material layer 1 and a surface layer 2 laminated on one surface of the base material layer. A resin sheet 14 illustrated in FIG. 1(c) is a laminated sheet including the base material layer 1, the surface layer 2 laminated on one surface of the base material layer, and a surface layer 3 laminated on the other surface of the base material layer. The surface layer 2 and the surface layer 3 may be layers having the same compositions or may be layers having different compositions.

<Base Material Layer>

Examples of a thermoplastic resin included in the base material layer (the first thermoplastic resin in the laminated sheet) include a styrene-based resin, a polycarbonate resin, and a polyester resin (PET, PBT, or the like). Regarding these thermoplastic resins, one kind can be used alone or two or more kinds can be used in combination.

Examples of a styrene-based resin include copolymers (AS, ABS, AES, MS, or the like) of a monomer such as acrylonitrile, butadiene, ethylene-propylene-diene, butadiene, or methylmethacrylate, and styrene.

Examples of an aromatic vinyl monomer constituting a styrene-based resin include styrene, vinyltoluene, o-methylstyrene, p-methylstyrene, p-tert-butylstyrene, 1,3-dimethylstyrene, α-methylstyrene, vinylnaphthalene, vinylanthracene, and 1,1-diphenylethylene. Among these aromatic vinyl monomers, styrene, vinyltoluene, o-methylstyrene, or the like can be used, and it is preferable to use styrene.

Examples of a polycarbonate resin include an aromatic polycarbonate resin, an aliphatic polycarbonate resin, and an aromatic-aliphatic polycarbonate. An aromatic polycarbonate resin is normally classified into engineer plastic, and a resin obtained by polycondensation of general bisphenol A and phosgene or by polycondensation of bisphenol A and a carbonic ester can be used. In regard to mechanical strength, an aromatic polycarbonate resin is preferably used.

Regarding a polyester resin, a resin obtained by polycondensation reaction of dicarboxylic acid and a diol can be used. Examples of dicarboxylic acid include phthalic acid, isophthalic acid, terephthalic acid, 2-methylterephthalic acid, 4,4′-diphenyldicarboxylic acid, 5-sulfoisophthalic acid, 2,6-naphthalenedicarboxylic acid, malonic acid, succinic acid, glutaric acid, adipic acid, maleic acid, and maleic anhydride. Regarding these, one kind can be used alone or two or more kinds can be used in combination. Examples of a diol include ethylene glycol, diethylene glycol, polyethylene glycol, propylene glycol, polypropylene glycol, and 1,3-propanediol. Regarding these, one kind can be used alone or two or more kinds can be used in combination.

The base material layer preferably includes at least one kind of a polycarbonate resin, an ABS resin, and an AS resin and preferably includes at least one kind of a polycarbonate resin and an ABS resin.

As long as the resin sheet of the present embodiment is within a range having the impact strength and the stress integrated value described above, one or more kinds of thermoplastic resins such as a polystyrene resin (GPPS), a high-impact polystyrene resin (rubber-modified styrene resin, HIPS), and an olefin-based resin may be included in the base material layer.

In the resin sheet of the present embodiment, from a viewpoint of achieving both curbing of occurrence of burrs, and folding resistance strength and moldability, the thickest layer (for example, the base material layer) may include at least one kind of a polycarbonate resin, an ABS resin, and an AS resin. The total content of these may be 80 mass % or more, may be 90 mass % or more, or may be 95 mass % or more based on the total amount of the layer.

In the resin sheet of the present embodiment, from a viewpoint of achieving both curbing of occurrence of burrs, and folding resistance strength and moldability, the thickest layer (for example, the base material layer) may include at least one kind of a polycarbonate resin and an ABS resin. The total content of these may be 85 mass % or more or may be 95 mass % or more based on the total amount of the resin included in the thickest layer.

Examples of an inorganic filler included in the base material layer include carbon black, graphite, CNT, black lead, calcium carbonate, talc, and silica. Regarding these inorganic fillers, one kind can be used alone or two or more kinds can be used in combination.

In order to improve compatibility with respect to a thermoplastic resin or dispersibility, an inorganic filler may be subjected to surface modification such as oxidation treatment or coating.

The shape of an inorganic filler is not particularly limited. However, a spherical shape, a needle shape, a plate shape, or a scale shape may be adopted.

From a viewpoint of achieving both curbing of occurrence of burrs, and folding resistance strength and moldability at a high level, the average primary particle size of an inorganic filler is preferably 10 nm to 5.0 μm, is more preferably 25 nm to 100 nm, and is much more preferably nm to 55 nm.

The average primary particle size of an inorganic filler is obtained by the following method.

First, a dispersion sample is prepared by dispersing a sample of an inorganic filler in chloroform for 10 minutes under conditions of 150 kHz and 0.4 kW using an ultrasonic disperser. This dispersion sample is sprinkled on a carbon-reinforced support film and is fixed. An image of this is captured using a transmission electron microscope (manufactured by JEOL LTD., JEM-2100). Particle sizes of 1,000 or more inorganic filler particles (the largest diameters in a case of shapes other than a spherical shape) are measured at random from an image magnified 50,000 to 200,000 times using an Endter's device, and the average value thereof is adopted as an average primary particle size.

The content of the inorganic filler in the base material layer can be 0.3 to 28 mass % based on the total amount of the base material layer. A single layer sheet and a laminated sheet including such a base material layer have a sufficient folding resistance strength and may be sheets in which burrs due to punching or slit processing are unlikely to be generated. From a viewpoint of further curbing occurrence of burrs, the content of the inorganic filler is preferably 0.9 to 28 mass and is more preferably 6 to 28 mass % based on the total amount of the base material layer. From a viewpoint of enhancing the folding resistance strength, the content of the inorganic filler is preferably 0.3 to 25 mass % and is more preferably 0.3 to 10 mass % based on the total amount of the base material layer.

From a viewpoint similar to that described above, the content of the inorganic filler in the base material layer may be 0.3 to 28 mass %, may be 0.9 to 28 mass %, may be 6 to 28 mass %, may be 0.3 to 25 mass %, or may be 0.3 to 10 mass % based on the total mass of the masses of the thermoplastic resin or the first thermoplastic resin and the inorganic filler.

Various kinds of additives such as a plasticizer, a processing aid, and a conductive material can be added to the base material layer.

The base material layer may be a layer into which a recycled material is mixed. Examples of a recycled material include a material obtained by crushing both end portions of a laminated sheet in which a base material layer and a surface layer are laminated, and an end material during a manufacturing step. A mixing ratio of a recycled material in the base material layer can be 2 to 30 mass %, may be 2 to 20 mass %, or may be 2 to 15 mass % based on the total amount of the base material layer.

When the resin sheet is a laminated sheet, the base material layer can include, as the first thermoplastic resin, a thermoplastic resin of the same kind as the second thermoplastic resin included in the surface layer and can include, as the inorganic filler, an inorganic filler made of the same material as the conductive material included in the surface layer. Such a base material layer can be formed by mixing in the recycled material described above. In this case, the amount of the recycled material mixed in can be suitably set such that the content of the inorganic filler in the base material layer is within the range described above.

When the resin sheet is a single layer sheet including a conductive material as an inorganic filler, examples of a conductive material include carbon black, graphite, CNT, black lead, and Ketjen black. Regarding these conductive materials, one kind can be used alone or two or more kinds can be used in combination. In this case, the resin sheet (base material layer) preferably has a surface resistivity of 10² to 10¹⁰Ω/□. If the surface resistivity of the resin sheet is within this range, it is easy to prevent destruction of the electronic components due to static electricity or destruction of the electronic components due to electricity which has flowed in from outside.

The average primary particle size of the conductive material may be 10 nm to 5.0 μm or may be 20 to 50 nm. The average primary particle size of the conductive material can be obtained by a method similar to that of the average primary particle size of the inorganic filler described above.

<Surface Layer>

When the resin sheet is a laminated sheet, a resin similar to the first thermoplastic resin described above can be used as the second thermoplastic resin included in the surface layer.

The surface layer preferably includes one or more kinds of a styrene-based resin, a polycarbonate resin, and a polyester resin.

Examples of the conductive material included in the surface layer include carbon black, graphite, CNT, black lead, and Ketjen black. Regarding these conductive materials, one kind can be used alone or two or more kinds can be used in combination.

A conductive material may be particles. In this case, the average primary particle size of the conductive material may be 10 nm to 5.0 μm or may be 20 to 50 nm. The average primary particle size of the conductive material can be obtained by a method similar to that of the average primary particle size of the inorganic filler described above.

The content of the conductive material in the surface layer can be 10 to 30 mass % or may be 20 to 30 mass % based on the total amount of the surface layer.

The surface layer preferably has a surface resistivity of 10² to 10¹⁰Ω/□. If the surface resistivity of the surface layer is within this range, it is easy to prevent destruction of the electronic components due to static electricity or destruction of the electronic components due to electricity which has flowed in from outside.

Various kinds of additives such as a lubricant, a plasticizer, and a processing aid can be added to the surface layer.

The thickness of the resin sheet can be suitably set in accordance with the purpose, and it can be 100 μm to 1.0 mm. When the resin sheet is used for a packaging container for miniaturized electronic components or a carrier tape, for example, it can be 100 to 300 μm.

When the resin sheet is a single layer sheet, the thickness of the base material layer (that is, the thickness of the resin sheet) may be 100 to 300 μm.

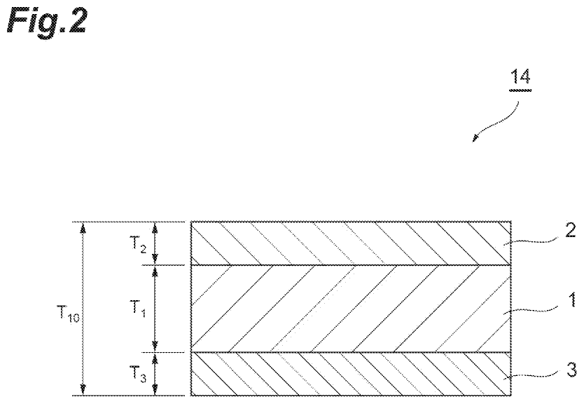

When the resin sheet is a laminated sheet, the thickness of the base material layer may be 100 to 300 μm. The thickness of the base material layer (T₁ in FIG. 2) can be 70% to 97% with respect to the thickness of the entire resin sheet (T₁₀ in FIG. 2). When the surface layer is provided on both surfaces of the base material layer, the thickness of the base material layer is preferably 70% to 94% with respect to the thickness of the entire resin sheet. As in the resin sheet 12 illustrated in FIG. 1(b), when the surface layer is provided on only one surface of the base material layer, the thickness of the base material layer is preferably 85% to 97% with respect to the thickness of the entire resin sheet.

The thickness of the surface layer may be 10 to 100 μm. As in the resin sheet 14 illustrated in FIG. 1(c), when the surface layer is provided on both surfaces of the base material layer, the thickness of each of the surface layers (T₂ and T₃ in FIG. 2) may be the same as or may differ from each other.

In the resin sheet of the present embodiment, the impact strength in a DuPont impact test is 1.0 J or greater, and a value obtained through integration from an origin point to a strain when fracture has occurred (which will hereinafter be referred to as “a stress strain curve integrated value”) is 80 N/m² or smaller in a stress strain curve obtained in a tensile test. Since the resin sheet of the present embodiment has such an impact strength and such a stress strain curve integrated value, it has a sufficient folding resistance strength and moldability and may be a sheet in which burrs due to punching or slit processing are unlikely to be generated.

The impact strength in a DuPont impact test indicates a 50% impact destruction energy value (unit: J) of JIS-K-7211 measured at an environmental temperature of 23° C. within a range having a load: 100 g to 1 kg and a height from an impact center to a test sample: 100 to 1,000 mm using a half-inch hemispherical impact center in a DuPont-type impact tester manufactured by TOYO SEIKI SEISAKU-SHO, LTD. Since the 50% impact destruction energy value is calculated from the load and the height at the time of 50% impact destruction of the resin sheet, the load and the height at the time of measurement are suitably adjusted within the foregoing range depending on the resin sheet.

The stress strain curve integrated value indicates a value obtained through integration from an origin point to a strain when fracture has occurred (fracture strain) in a stress strain curve obtained in the following tensile test.

(Tensile Test)

In conformity with JIS-K-7127 (1999), measurement is performed under a condition of a tensile speed of 5 mm/min with a test piece type-5 which has been sampled while having the flowing direction of the sheet as the length direction using Strograph VE-1D manufactured by TOYO SEIKI SEISAKU-SHO, LTD.

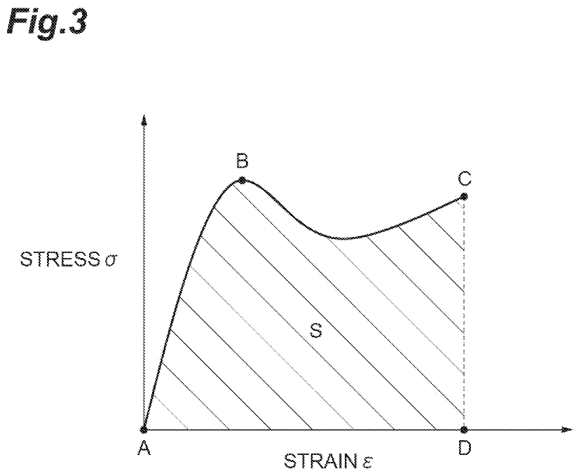

For example, a stress strain curve illustrated in FIG. 3 can be obtained by performing a tensile test of the resin sheet. In FIG. 3, A indicates an origin point (stress zero), B indicates a yield point, C indicates a fracture point, and D indicates a fracture strain. The area S in FIG. 3 indicates the stress strain curve integrated value.

In the resin sheet of the present embodiment, from a viewpoint of achieving both curbing of occurrence of burrs, and folding resistance strength and moldability, the impact strength in a DuPont impact test may be 1.0 J or greater, may be 1.5 J or greater, or may be 2.0 J or greater.

In the resin sheet of the embodiment, from a viewpoint of achieving both curbing of occurrence of burrs, and folding resistance strength and moldability, the foregoing stress strain curve integrated value may be 0 to 80 N/m², may be 10 to 70 N/m², or may be 30 to 60 N/m².

The resin sheet of the present embodiment may be a raw material sheet which has not been processed or may be a slit product or the like which has been subjected to predetermined processing.

The resin sheet of the present embodiment can be molded into a shape according to the purpose by a known thermal molding method such as a vacuum molding method, a pressure molding method, and a press molding method.

The resin sheet of the present embodiment can be used as a material of a packaging container for active components such as ICs, components including an IC, passive components such as capacitors and connectors, and mechanism components and can be favorably used for vacuum-molded trays, magazines, carrier tapes provided with embossing (embossed carrier tapes), and the like.

According to the resin sheet of the present embodiment, since burrs due to punching or slit processing are unlikely to be generated, burrs generated during slitting can be extremely reduced in slit products, and burrs generated in cross sections of sprocket holes during punching of the sprocket holes can be extremely reduced in embossed carrier tapes. In addition, according to the resin sheet of the present embodiment, since the resin sheet has a sufficient folding resistance strength and moldability, occurrence of cracking in a molded body can be curbed.

[Method for Manufacturing Resin Sheet]

The resin sheet according to the present embodiment can be manufactured by a general method. For example, when the resin sheet is a single layer sheet, the resin sheet can be manufactured by preparing a pellet which has been pelletized as a base material layer forming composite for forming a base material layer by kneading a raw material constituting a base material layer using a known method such as an extruder, and making a single layer sheet using this pellet by a known method such as an extruder. In addition, when the resin sheet is a laminated sheet, the resin sheet can be manufactured by preparing a pellet which has been pelletized as a base material layer forming composite for forming a base material layer by kneading a raw material constituting a base material layer using a known method such as an extruder and a pellet which has been pelletized as a surface layer forming composite for forming a surface layer by kneading a raw material constituting a surface layer using a known method such as an extruder, and making a laminated sheet using these pellets by a known method such as an extruder. For example, the temperature of the extruder can be set to 200° C. to 280° C.

The base material layer and the surface layer may be laminated in stages by a thermal lamination method, a dry lamination method, an extrusion lamination method, or the like after each of a base material layer forming composite and a surface layer forming composite is molded to have a sheet shape or a film shape using different extruders, or a surface layer made of a surface layer forming composite may be laminated on one surface or both surfaces of a base material layer sheet which has been molded with a base material layer forming composite in advance by a method such as extrusion coating.

In addition, a laminated sheet can be manufactured by respectively supplying raw materials constituting a base material layer and a surface layer (for example, the foregoing pellets) to individual extruders by a multilayer coextrusion method such as extrusion molding using a multilayer T-die having multiple manifolds, or a T-die method extrusion molding using a feed block. This method is preferable in that a laminated sheet can be obtained in one step.

When a recycled material is mixed into a base material layer, a raw material of a base material layer and a recycled material can be supplied to an extruder for forming a base material layer. In this case, the amount of the raw material mixed in to be supplied to an extruder is suitably adjusted in accordance with the kind and the amount of the recycled material mixed in such that a predetermined composition of the base material layer can be obtained.

[Container, Carrier Tape, and Electronic Component Packaging Body]

A container of the present embodiment is a molded body of the foregoing resin sheet according to the present embodiment. A container can be obtained by molding the resin sheet according to the present embodiment into a shape according to the purpose. Regarding a molding method, a known thermal molding method such as a vacuum molding method, a pressure molding method, or a press molding method can be used.

Examples of a molding temperature include a temperature within a range of 100° C. to 500° C.

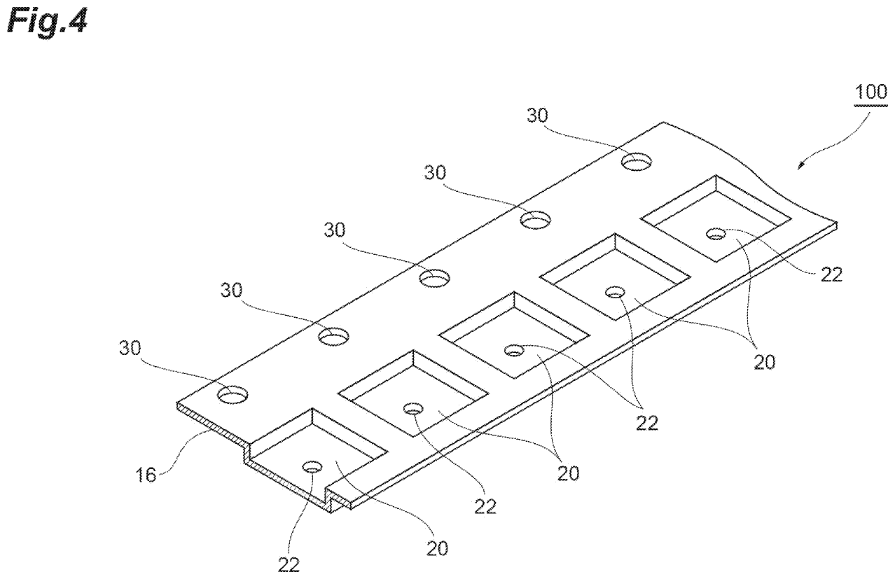

A carrier tape of the present embodiment is a molded body of the foregoing resin sheet according to the present embodiment and is provided with accommodation portions capable of accommodating articles. FIG. 4 is a perspective view illustrating an embodiment of a carrier tape. A carrier tape 100 illustrated in FIG. 4 is an embossed carrier tape constituted of a molded body 16 of the resin sheet according to the present embodiment in which accommodation portions 20 are provided by embossing molding. The molded body 16 is provided with sprocket holes 30 which can be used for conveyance in a step of enclosing various kinds of electronic components such as ICs, or the like. Holes 22 may be provided in bottom portions of the accommodation portions for inspection of electronic components.

The sprocket holes 30 can be provided by punching processing, for example. In the resin sheet according to the present embodiment, since burrs generated in punched cross sections can be extremely reduced, even when the diameters of the sprocket holes 30 are small, it is possible to sufficiently reduce the influences of incorporation of foreign matters into components due to separation of burrs and a short circuit during mounting caused by the incorporation of foreign matters. For this reason, the carrier tape of the present embodiment is suitable for a packaging container for miniaturized electronic components.

In the carrier tape of the present embodiment, the punching burr ratio in the sprocket holes having the foregoing shape can become 7.0% or smaller and preferably smaller than 5%. Here, the punching burr ratio denotes a ratio of the area of burrs to a predetermined punching area in which burrs are not generated when viewed in a punching direction. For example, when the punching shape is a true circle, the punching area indicates the area of the true circle having no burrs.

The carrier tape of the present embodiment can be wound in a reel shape.

The carrier tape of the present embodiment is suitable for a container for packaging electronic components. Examples of electronic components include ICs, light emitting diodes (LEDs), resistors, liquid crystals, capacitors, transistors, piezoelectric element resistors, filters, crystal oscillators, crystal vibrators, diodes, connectors, switches, volumes, relays, and inductors. Electronic components may be intermediate products using the foregoing components or may be final products.

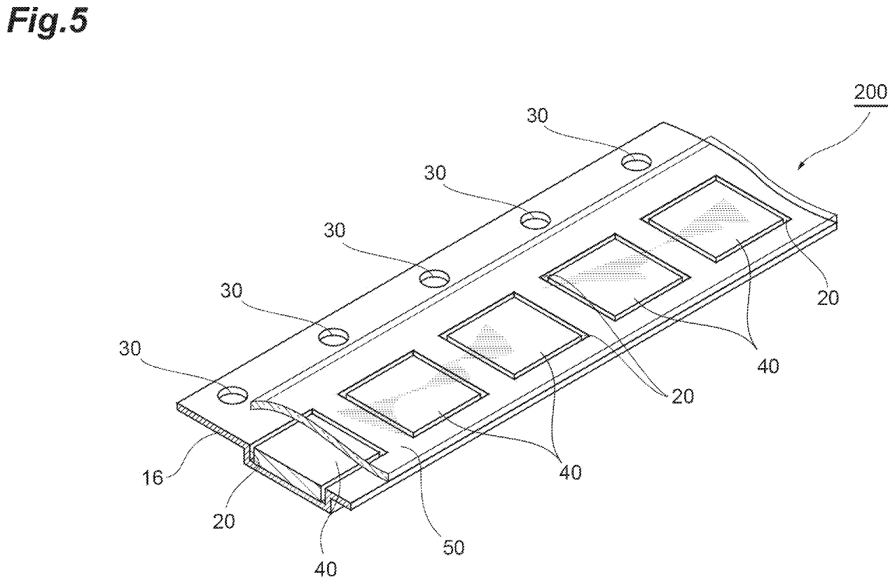

An electronic component packaging body of the present embodiment includes the foregoing carrier tape of the present embodiment, electronic components accommodated in the accommodation portions of the carrier tape, and a cover film adhered to the carrier tape as a lid material. FIG. 5 is a partially-cut perspective view illustrating an embodiment of an electronic component packaging body. An electronic component packaging body 200 illustrated in FIG. includes an embossed carrier tape constituted of the molded body 16 of the resin sheet according to the present embodiment provided with the accommodation portions 20 and the sprocket holes 30, electronic components 40 accommodated in the accommodation portions 20, and a cover film 50 adhered to the embossed carrier tape.

Examples of a cover film include those disclosed in Japanese Patent No. 4630046 and Japanese Patent No. 5894578.

The cover film can be adhered to the upper surface of the embossed carrier tape accommodating the electronic components by heat sealing.

The electronic component packaging body of the present embodiment can be used for storing and conveying electronic components as a carrier tape body wound in a reel shape.

### EXAMPLE

Hereinafter, the present invention will be more specifically described with examples and comparative examples. However, the present invention is not limited to the following examples.

[Production of Resin Sheet]

### Examples 1 to 18 and Comparative Examples 1 to 6: Single Layer Sheet

Each of the raw materials shown in Tables 1 to 3 was measured such that it has the composition ratio (mass %) shown in the same tables, and the raw materials were uniformly mixed using a high-speed mixer. Thereafter, they were kneaded using a vent-type twin screw extruder (ϕ45 mm) and were pelletized by a strand cutting method, and a base material layer forming resin composition was obtained. Using this composite, a single layer sheet made of a base material layer was produced by means of an extruder (ϕ30 mm) (L/D=28). The thickness of the single layer sheet was 200 μm.

### Examples 19 to 30 and Comparative Examples 7 to 8: Laminated Sheet

Each of the raw materials shown in Tables 4 and 5 was measured such that it has the composition ratio (mass %) shown in the same tables, and the raw materials were uniformly mixed using a high-speed mixer. Thereafter, they were kneaded using a vent-type twin screw extruder (ϕ45 mm) and were pelletized by a strand cutting method, and each of a surface layer forming resin composition and a base material layer forming resin composition was obtained. Using these composites, a laminated sheet having a laminated structure (surface layer/base material layer/surface layer) was produced by a feed block method using an extruder (ϕ65 mm) (L/D=28), an extruder (ϕ40 mm) (L/D=26), and a T-die having a width of 500 mm. The thickness of the laminated sheet was 200 μm, and the ratio of the thicknesses (surface layer/base material layer/surface layer) was 1:18:1.

Details of the raw materials shown in Tables 1 to 5 are as follows.

PC: polycarbonate resin (manufactured by TEIJIN LTD., product name “Panlite L-1225L”)

ABS: acrylonitrile-butadiene-styrene copolymer (manufactured by DENKA CO., LTD., product name “SE-10”)

AS: acrylonitrile-styrene copolymer (manufactured by DENKA CO., LTD., product name “GR-ATR”) GPPS: polystyrene resin (manufactured by TOYO STYRENE

CO., LTD., product name “G200C”)

HIPS: high-impact polystyrene resin (manufactured by TOYO STYRENE CO., LTD., product name “E640N”)

HDPE: high-density polyethylene (manufactured by JAPAN POLYETHYLENE CORPORATION, product name “HF313”)

LLDPE: linear low-density polyethylene (manufactured by UBE-MARUZEN POLYETHYLENE CO., LTD., product name “NOVADURAN 5010R8M”)

PBT: polybutylene terephthalate resin (manufactured by MITSUBISHI ENGINEERING-PLASTICS CORPORATION, product name “NOVADURAN 5010R8M”)

Carbon black: acetylene black (manufactured by DENKA CO., LTD., product name “DENKA BLACK particles”, average primary particle size of 35 nm)

The average primary particle size of the inorganic filler was obtained by the following method.

First, a dispersion sample was prepared by dispersing a sample of an inorganic filler in chloroform for 10 minutes under conditions of 150 kHz and 0.4 kW using an ultrasonic disperser. This dispersion sample was sprinkled on a carbon-reinforced support film and was fixed. An image of this was captured using a transmission electron microscope (manufactured by JEOL LTD., JEM-2100). Particle sizes of 1,000 or more inorganic filler particles (the largest diameters in a case of shapes other than a spherical shape) were measured at random from an image magnified 50,000 to 200,000 times using an Endter's device, and the average value thereof was adopted as the average primary particle size.

[Characteristics of Resin Sheet]

Sampling was performed in the extrusion direction of the resin sheet, and the DuPont impact strength and the stress strain curve integrated value were obtained by the method described below. Tables 1 to 5 summarize these results.

(DuPont Impact Strength)

In the impact strength in a DuPont impact test, the 50% impact destruction energy value (unit: J) of JIS-K-7211 was measured at an environmental temperature of 23° C. within a range having a load: 100 g to 1 kg and a height from an impact center to a test sample: 100 to 1,000 mm using a half-inch hemispherical impact center in a DuPont-type impact tester manufactured by TOYO SEIKI SEISAKU-SHO, LTD. Since the 50% impact destruction energy value was calculated from the load and the height at the time of 50% impact destruction of the resin sheet, the load and the height at the time of measurement were suitably adjusted within the foregoing range depending on the resin sheet. The 50% impact destruction energy value could be calculated within a setting load range of 300 to 500 g in Examples 1 to 18 and within a setting load range of 100 to 300 g in Comparative Examples 1 to 6.

(Stress Strain Curve Integrated Value)

The stress strain curve was obtained in the following tensile test. A value obtained through integration from the origin point in the obtained stress strain curve to a strain when fracture occurred (fracture strain) was calculated.

(Tensile Test)

In conformity with JIS-K-7127 (1999), measurement was performed under a condition of a tensile speed of 5 mm/min with a test piece type-5 which has been sampled while having the flowing direction of the sheet as the length direction using Strograph VE-1D manufactured by TOYO SEIKI SEISAKU-SHO, LTD.

[Evaluation of Resin Sheet]

Sampling was performed in the extrusion direction of the resin sheet, and evaluation was performed by the method described below. Tables 1 to 5 summarize these results.

(1) Punching Burr Ratio

In the sheet sample which was left behind for 24 hours under an atmosphere at a temperature of 23° C. and a relative humidity of 50%, punching holes were provided under an atmosphere at a temperature of 23° C. and a relative humidity of 50% using a vacuum rotary molding machine (CT8/24) manufactured by Muehlbauer. Punching was performed at a speed of 240 m/h using a punching apparatus including a columnar punching pin having a sprocket hole pin tip diameter of 1.5 mm and a die hole having a diameter of 1.58 mm.

Images of the sheet punched holes formed as described above were captured in a light source environment in which incident light was 0%, transmission was 40%, and the ring was 0% using a microscopic measuring machine (manufactured by MITUTOYO CORPORATION, product name “MF-A1720H (image unit 6D)”). In the captured images, a threshold 128 was designated by means of a two-tone filter using Adobe Photoshop Elements 14 (Adobe, product name), and processing was performed such that only the parts of the sprocket holes became white. The number of pixels corresponding to the sizes of the holes having a diameter of 1.5 mm was defined as “the number of white pixels of the sprocket holes having no burrs”. The number of white pixels was recorded, and the punching burr ratio was obtained from the following Expression.

Punching burr ratio (%)=(1−(recorded number of white pixels)/(number of white pixels of sprocket holes having no burrs))×100

In addition, the results judged based on the following judgment criterion on the basis of the punching burr ratio obtained as above are also presented.

<Judgment Criterion>

A: Burr ratio was smaller than 5%.

B: Burr ratio was 5% to 7%.

C: Burr ratio exceeded 7%.

(2) Folding Resistance Strength

From the sheet sample, in conformity with JIS-P-8115 (2001), test pieces having a length of 150 mm in the sheet extrusion direction, a width of 15 mm, and a thickness of 0.25 mm were produced. The test pieces were left behind for 24 hours under an atmosphere at a temperature of 23° C. and a relative humidity of 50%. Thereafter, the MIT folding resistance strength was measured using a MIT folding fatigue tester manufactured by TOYO SEIKI SEISAKU-SHO, LTD. under an atmosphere at a temperature of 23° C. and a relative humidity of 50%. Measurement was performed under conditions of a bending angle of 135 degrees, a bending speed of 175 times per minute, and a measurement load of 250 g. While this measurement was repeated, the number of times of bending when the test piece was broken was evaluated as the folding resistance strength.

In addition, the results judged based on the following judgment criterion on the basis of the number of times of bending obtained as above are also presented.

<Judgment Criterion>

A: The number of times of bending was 30 times or larger.

B: The number of times of bending was 10 times to smaller than times.

C: The number of times of bending was smaller than 10 times.

(3) Moldability

The resin sheet was molded using a pressure molding machine under a condition of a heater temperature of 210° C., and a carrier tape having a width of 24 mm provided with a pocket having a size of 15 mm in the flowing direction, 11 mm in the width direction, and 5 mm in the depth direction was made. Each of the bottom surface and two side surfaces (a first side surface and a second side surface) of the pocket of this carrier tape was cut out, and moldability evaluation was performed by thickness measurement using a shape measurement laser microscope manufactured by KEYENCE CORPORATION.

While having the average value of the thickness of the first side surface and the thickness of the second side surface as the thickness of the side surface, the thickness difference between the bottom surface and the side surface was obtained, the ratio R (%) of the thickness difference was calculated in accordance with the following expression, and the moldability was evaluated based on the following judgment criterion.

R=(Δt/tA)×100

[in the expression, Δt indicates the thickness difference between the bottom surface and the side surface, and to indicates the average value of the thicknesses of the bottom surface, the first side surface, and the second side surface]

<Judgment Criterion>

A: R was smaller than 10%.

B: R was 10% to 20%.

C: R exceeded 20%.

TABLE 1

| | | Exam- | Exam- | Exam- | Exam- | Exam- | Exam- | Exam- | Exam- | Exam- |
|---|---|---|---|---|---|---|---|---|---|---|
| | | ple 1 | ple 2 | ple 3 | ple 4 | ple 5 | ple 6 | ple 7 | ple 8 | ple 9 |
| Base | PC | 100 | — | 50 | 50 | 43 | 36 | 30 | 29 | 63 |
| material | ABS | — | 100 | 50 | 49 | 42 | 36 | 70 | 70 | 22 |
| layer | AS | — | — | — | — | — | — | — | — | — |
| | GPPS | — | — | — | — | — | — | — | — | — |
| | HIPS | — | — | — | — | — | — | — | — | — |
| | PMMA | — | — | — | — | — | — | — | — | — |
| | HDPE | — | — | — | — | — | — | — | — | — |
| | LLDPE | — | — | — | — | — | — | — | — | — |
| | PBT | — | — | — | — | — | — | — | — | — |
| | Carbon black | — | — | — | 1 | 15 | 28 | — | 1 | 15 |
| Stress strain curve integrated | | 51.2 | 24.7 | 49.9 | 48.5 | 40.2 | 35.8 | 49.5 | 47.9 | 40.8 |
| value (N/m²) | | | | | | | | | | |
| DuPont impact strength ( J) | | 2.50 | 1.66 | 2.46 | 2.40 | 2.24 | 2.00 | 2.25 | 2.20 | 2.05 |
| Evaluation | Punching burr | 0.67 | 5.59 | 1.27 | 1.25 | 0.9 | 0.5 | 1.75 | 1.74 | 1.30 |
| | ratio (%) | | | | | | | | | |
| | Judgment | A | B | A | A | A | A | A | A | A |
| | Folding resistance | 15 | 25 | 20 | 19 | 15 | 11 | 25 | 24 | 20 |
| | strength (times) | | | | | | | | | |
| | Judgment | B | B | B | B | B | B | B | B | B |
| | Moldability R (%) | 17 | 8 | 15 | 15 | 17 | 20 | 12 | 12 | 15 |
| | Judgment | B | A | B | B | B | B | B | B | B |

TABLE 2

| | | Exam- | Exam- | Exam- | Exam- | Exam- | Exam- | Exam- | Exam- | Exam- |
|---|---|---|---|---|---|---|---|---|---|---|
| | | ple 10 | ple 11 | ple 12 | ple 13 | ple 14 | ple 15 | ple 16 | ple 17 | ple 18 |
| Base | PC | 16 | 50 | — | — | — | — | 99 | 85 | 72 |
| material | ABS | 56 | 35 | 70 | 70 | 63 | 56 | — | — | — |
| layer | AS | — | 15 | 30 | 29 | 22 | 16 | — | — | — |
| | GPPS | — | — | — | — | — | — | — | — | — |
| | HIPS | — | — | — | — | — | — | — | — | — |
| | PMMA | — | — | — | — | — | — | — | — | — |
| | HDPE | — | — | — | — | — | — | — | — | — |
| | LLDPE | — | — | — | — | — | — | — | — | — |
| | PBT | — | — | — | — | — | — | — | — | — |
| | Carbon black | 28 | — | — | 1 | 15 | 28 | 1 | 15 | 28 |
| Stress strain curve integrated | | 34.6 | 55.6 | 5.3 | 5.1 | 4.4 | 3.6 | 50 | 46.1 | 43.6 |
| value (N/m²) | | | | | | | | | | |
| DuPont impact strength (J) | | 1.55 | 2.43 | 1.45 | 1.45 | 1.25 | 1.05 | 2.48 | 2.27 | 2.01 |
| Evaluation | Punching burr | 1.00 | 2.91 | 5.22 | 5.14 | 4.96 | 4.51 | 0.6 | 0.52 | 0.3 |
| | ratio (%) | | | | | | | | | |
| | Judgment | A | A | B | B | A | A | A | A | A |
| | Folding resistance | 14 | 18 | 20 | 19 | 15 | 11 | 14 | 12 | 10 |
| | strength (times) | | | | | | | | | |
| | Judgment | B | B | B | B | B | B | B | B | B |
| | Moldability R (%) | 17 | 15 | 9 | 10 | 13 | 15 | 18 | 19 | 20 |
| | Judgment | B | B | A | B | B | B | B | B | B |

TABLE 3

| | | Comparative | Comparative | Comparative | Comparative | Comparative | Comparative |
|---|---|---|---|---|---|---|---|
| | | Example 1 | Example 2 | Example 3 | Example 4 | Example 5 | Example 6 |
| Base | PC | — | — | — | — | — | — |
| material | ABS | — | — | — | — | — | — |
| layer | AS | 100 | — | — | — | — | — |
| | GPPS | — | 100 | — | — | — | 50 |
| | HIPS | — | — | — | — | — | 50 |
| | PMMA | — | — | 100 | — | — | — |
| | HDPE | — | — | — | 100 | — | — |
| | LLDPE | — | — | — | — | 100 | — |
| | PBT | — | — | — | — | — | — |
| | Carbon black | — | — | — | — | — | — |
| Stress strain curve integrated | | 1.8 | 1.8 | 27.1 | 107.4 | 129.1 | 19.8 |
| value (N/m²) | | | | | | | |
| DuPont impact strength (J) | | 0.07 | 0.03 | 0.13 | 1.50 | 1.36 | 0.41 |
| Evaluation | Punching burr | 5.36 | 7.52 | 11.15 | 13.83 | 5.76 | 3.39 |
| | ratio (%) | | | | | | |
| | Judgment | B | C | C | C | B | A |
| | Folding resistance | 5 | 1 | 5 | 100 | 100 | 8 |
| | strength (times) | | | | | | |
| | Judgment | C | C | C | A | A | C |
| | Moldability R (%) | 25 | 30 | 30 | 30 | 30 | 22 |
| | Judgment | C | C | C | C | C | C |

TABLE 4

| | | Exam- | Exam- | Exam- | Exam- | Exam- | Exam- | Exam- | Exam- | Exam- |
|---|---|---|---|---|---|---|---|---|---|---|
| | | ple 19 | ple 20 | ple 21 | ple 22 | ple 23 | ple 24 | ple 25 | ple 26 | ple 27 |
| Surface | PC | 60 | 60 | 60 | 60 | 60 | 60 | 60 | 60 | 60 |
| layer | PBT | 25 | 25 | 25 | 25 | 25 | 25 | 25 | 25 | 25 |
| | Carbon black | 15 | 15 | 15 | 15 | 15 | 15 | 15 | 15 | 15 |
| Base | PC | — | — | — | — | — | — | — | 100 | 50 |
| material | ABS | 100 | 70 | 70 | 63 | 56 | 50 | — | — | 50 |
| layer | AS | — | 30 | 29 | 22 | 16 | 50 | 100 | — | — |
| | GPPS | — | — | — | — | — | — | — | — | — |
| | HIPS | — | — | — | — | — | — | — | — | — |
| | PMMA | — | — | — | — | — | — | — | — | — |
| | HDPE | — | — | — | — | — | — | — | — | — |
| | LLDPE | — | — | — | — | — | — | — | — | — |
| | PBT | — | — | — | — | — | — | — | — | — |
| | Carbon black | — | — | 1 | 15 | 28 | — | — | — | — |
| Stress strain curve integrated | | 3 | 2.6 | 2.4 | 1.9 | 1.1 | 2 | 1 | 10 | 5 |
| value (N/m²) | | | | | | | | | | |
| DuPont impact strength (J) | | 1.50 | 1.72 | 1.70 | 1.50 | 1.40 | 1.60 | 1.20 | 2.00 | 1.70 |
| Evaluation | Punching burr | 6 | 6.33 | 6 | 5.14 | 4.92 | 5 | 5 | 0.90 | 1.10 |
| | ratio (%) | | | | | | | | | |
| | Judgment | B | B | B | B | A | B | B | A | A |
| | Folding resistance | 20 | 18 | 17 | 14 | 10 | 15 | 11 | 12 | 16 |
| | strength (times) | | | | | | | | | |
| | Judgment | B | B | B | B | B | B | B | B | B |
| | Moldability R (%) | 10 | 12 | 13 | 15 | 17 | 14 | 18 | 18 | 12 |
| | Judgment | B | B | B | B | B | B | B | B | B |

TABLE 5

| | | | | | Comparative | Comparative |
|---|---|---|---|---|---|---|
| | | Example 28 | Example 29 | Example 30 | Example 7 | Example 8 |
| Surface | PC | 60 | 60 | 60 | 60 | 50 |
| layer | PBT | 25 | 25 | 25 | 25 | 20 |
| | Carbon black | 15 | 15 | 15 | 15 | 30 |
| Base | PC | 50 | 43 | 36 | — | — |
| material | ABS | 49 | 42 | 36 | — | 100 |
| layer | AS | — | — | — | — | — |
| | GPPS | — | — | — | 100 | — |
| | HIPS | — | — | — | — | — |
| | PMMA | — | — | — | — | — |
| | HDPE | — | — | — | — | — |
| | LLDPE | — | — | — | — | — |
| | PBT | — | — | — | — | — |
| | Carbon black | 1 | 15 | 28 | — | — |
| Stress strain curve integrated | | 4.9 | 3.5 | 2.1 | 0.8 | 1 |
| value (N/m²) | | | | | | |
| DuPont impact strength (J) | | 1.69 | 1.45 | 1.10 | 0.09 | 0.95 |
| Evaluation | Punching burr | 1.08 | 0.90 | 0.51 | 7.20 | 6 |
| | ratio (%) | | | | | |
| | Judgment | A | A | A | C | B |
| | Folding resistance | 15 | 13 | 10 | 5 | 8 |
| | strength (times) | | | | | |
| | Judgment | B | B | B | C | C |
| | Moldability R (%) | 13 | 17 | 20 | 25 | 22 |
| | Judgment | B | B | B | C | C |

As shown in Tables 1, 2, 4, and 5, in the resin sheets of Examples 1 to 30 in which the DuPont impact strength was 1.0 J or greater and the stress strain curve integrated value was 80 N/m² or smaller, it was confirmed that the judgment in all of the punching burr ratio, the folding resistance strength, and the moldability was B or A.

Meanwhile, in the resin sheets of Comparative Examples 1 to 8 in which the DuPont impact strength was smaller than 1.0 J or the stress strain curve integrated value exceeded 80 N/m², the judgment was C in one or more items of the punching burr ratio, the folding resistance strength, and the moldability.

### REFERENCE SIGNS LIST

1 Base material layer
2, 3 Surface layer
10, 12, 14 Resin sheet
16 Molded body
20 Accommodation portion
22 Hole
30 Sprocket hole
40 Electronic component
50 Cover film
100 Carrier tape
200 Electronic component packaging body

1. A resin sheet for molding,
wherein the impact strength in a DuPont impact test is 1.0 J or greater, and
wherein in a stress strain curve obtained in a tensile test, a value obtained through integration from an origin point to a strain when fracture has occurred is 80 N/m² or smaller.

2. The resin sheet according to claim 1,
wherein at least one kind of a polycarbonate resin and an ABS resin is contained.

3. The resin sheet according to claim 1 comprising:
a base material layer; and
a surface layer laminated on at least one surface of the base material layer,
wherein the base material layer includes at least one kind of a polycarbonate resin and an ABS resin, and an inorganic filler, and
wherein the surface layer includes at least one kind of a polycarbonate resin and an ABS resin, and a conductive material.

4. The resin sheet according to claim 3,
wherein a content of the inorganic filler in the base material layer is 0.3 to 28 mass % based on a total amount of the base material layer.

5. The resin sheet according to claim 3,
wherein an average primary particle size of the inorganic filler is 10 nm to 5.0 μm.

6. The resin sheet according to claim 3,
wherein the base material layer includes carbon black as the inorganic filler.

7. The resin sheet according to claim 3,
wherein a content of the conductive material in the surface layer is 10 to 30 mass % based on a total amount of the surface layer.

8. The resin sheet according to claim 3,
wherein a thickness of the base material layer is 70% to 97% with respect to a thickness of the entire resin sheet.

9. A container that is a molded body of the resin sheet according to claim 1.

10. A carrier tape that is a molded body of the resin sheet according to claim 1,
wherein an accommodation portion capable of accommodating an article is provided.

11. An electronic component packaging body comprising:
the carrier tape according to claim 10;
an electronic component accommodated in the accommodation portion of the carrier tape; and
a cover film adhered to the carrier tape as a lid material.
